(19) United States
(12) Patent Application Publication
(10) Pub. No.: US 2025/0193274 A1
(43) Pub. Date: Jun. 12, 2025

(54) EVENT-BASED OPTIMAL FAAS CONNECTION METHOD AND DEVICE IN A DISTRIBUTED EDGE CLOUD ENVIRONMENT

(71) Applicant: FOUNDATION OF SOONGSIL UNIVERSITY-INDUSTRY COOPERATION, Seoul (KR)

(72) Inventors: Young Han KIM, Seoul (KR); Min Jin KIM, Seoul (KR)

(73) Assignee: FOUNDATION OF SOONGSIL UNIVERSITY-INDUSTRY COOPERATION, Seoul (KR)

(21) Appl. No.: 18/954,446

(22) Filed: Nov. 20, 2024

(30) Foreign Application Priority Data
Dec. 11, 2023 (KR) 10-2023-0178902

(51) Int. Cl. H04L 67/1008; H04L 67/1001; H04L 67/60

(52) U.S. Cl. CPC H04L 67/1008; H04L 67/10015; H04L 67/60

(57) ABSTRACT

An event-based optimal FaaS connection method includes: generating, by a transformation component of a first cluster among a plurality of clusters, a second event by changing an event metadata type value according to whether a function to be executed by a first event detected by the first cluster exists in the first cluster; passing, by a first event broker component of the first cluster, the second event to a trigger service component of a mediator cluster when the function to be executed does not exist in the first cluster; filtering, by the trigger service component, a target cluster by referencing resource monitoring information of each cluster environment and a pre-defined function selection criterion file, and generating a third event corresponding to the target cluster; and passing, by a second event broker component corresponding to the filtered target cluster of the mediator cluster, the third event to the first event broker component.

### CROSS-REFERENCE TO RELATED APPLICATION

This application claims the benefit of priority under 35 U.S.C. § 119 (a) to Korean Patent Application No. 10-2023-0178902 filed on Dec. 11, 2023, the entire contents of which are incorporated herein by reference.

### BACKGROUND

### (a) Technical Field

The present disclosure relates to a method and a device for event-based optimal FaaS connection in a distributed edge cloud environment.

### (b) Background Art

Function-as-a-Service (FaaS) is a serverless computing service in a distributed edge cloud environment which can execute a code in response to an event without managing a complicated infrastructure generally involved in constructing and executing a microservice application.

When implementing a serverless function in the existing distributed edge cloud environment, information about a broker for routing an event in a cloud and a target to process the event should be set in order to call a function using the event.

In such a structure, design and maintenance are complicated because all clouds need to add broker information when creating a new cloud.

In addition, when the same function exists in multiple clouds, there is a problem in which all functions are called by calling the function of the cloud defined as a target because there is no criterion for which cloud a function should be called. In addition, even when a function is called in a current cloud, efficiency of a performance deteriorates when many functions are already running.

### PRIOR ART DOCUMENT

### Patent Document

KR Laid-open Patent Publication No. 10-2018-0071200

### SUMMARY OF THE DISCLOSURE

To solve the problems in the above-described related art, the present disclosure is to provide a method and a device of event-based optimal FaaS connection in a distributed edge cloud environment, which simplify design and maintenance, and are capable of enhancing efficiency of function calling.

In order to achieve the object, according to an aspect of the present disclosure, provided is an event-based optimal FaaS connection method in a distributed edge cloud environment, which includes the steps of: generating, by a transformation component of a first cluster among a plurality of clusters, a second event by changing an event metadata type value according to whether a function to be executed by a first event detected by the first cluster exists in the first cluster; passing, by a first event broker component of the first cluster, the second event to a trigger service component of a mediator cluster when the function to be executed does not exist in the first cluster; filtering, by the trigger service component, a target cluster by referencing resource monitoring information of each cluster environment and a pre-defined function selection criterion file, and generating a third event corresponding to the target cluster; and passing, by a second event broker component corresponding to the selected target cluster of the mediator cluster, the third event to the first event broker component.

The transformation component may change the type value to 1 corresponding to local when the function exists in the first cluster, and change the type value to 2 corresponding to others when the function does not exist in the first cluster.

The trigger service component may generate a third event by changing a metadata type value of the second event to 1 corresponding to local.

The resource monitoring information may include a CPU/memory usage and a network speed.

When a plurality of target cluster candidates are filtered by using resource monitoring information of each cluster environment, the trigger service component may filter one of the plurality of target cluster candidates as the target cluster by referencing the pre-defined function selection criterion file.

When the plurality of target clusters are determined by referencing the pre-defined function selection criterion file, the trigger service component may randomly filter one target cluster.

The mediator cluster may include a plurality of event brokers corresponding to the plurality of clusters.

According to another aspect of the present disclosure, provided is an event-based optimal FaaS connection device in a distributed edge cloud environment, which includes: a trigger service component receiving, when a function to be executed by a first event detected by a first cluster among a plurality of clusters does not exist, a second event in which a metadata type value of the first event is changed from the first cluster, and filtering a target cluster by using resource monitoring information of each of the plurality of clusters, and a pre-defined function selection criterion, and generating a third event corresponding to the target cluster; and a plurality of event broker components corresponding to the plurality of clusters, wherein an event broker component corresponding to the filtered target cluster among the plurality of event broker components passes the third event to the target cluster.

According to yet another aspect of the present disclosure, provided is an event-based optimal FaaS connection system in a distributed edge cloud environment, which includes: a plurality of clusters including a source component detecting a first event, a transformation component generating a second event by changing a metadata type value of the first event according to whether a function to be executed by the first event exists in a cluster thereof, and an event broker component routing the second event when the function does not exist in a cluster thereof; and a mediator cluster including a trigger service component filtering a target cluster by referencing resource monitoring information of each cluster environment, and a pre-defined function selection criterion, and generating a third event corresponding to the target cluster, when receiving the second event from an event broker component of one cluster among the plurality of clusters, and a plurality of event broker components corresponding to the plurality of clusters, wherein an event broker component corresponding to the filtered target cluster among the plurality of event broker components passes the third event to an event broker component included in the filtered target cluster.

According to the present disclosure, a structure is proposed, which coordinates an event overall when a serverless function is implemented in a distributed edge cloud environment, and there is an advantage in that when the same function exists in several clouds by providing a mediator cluster, an optimal function in terms of a user can be selected by variously defining selection criteria of a function.

Further, according to the present disclosure, there is an advantage in that since each cloud does not need to know a broker and a function which exist in another cloud, it is efficient to extend, or design and maintain a cloud.

### BRIEF DESCRIPTION OF DRAWINGS

FIG. 1 is a diagram illustrating an event-based optimal FaaS connection system introducing a mediator cluster according to an embodiment.

FIG. 2A and FIG. 2B are a diagram illustrating an overall operating process according to an embodiment.

FIG. 3 is a flowchart illustrating an optimal function selecting process of a trigger service component according to an embodiment.

### DETAILED DESCRIPTION

The present disclosure can be modified in various ways and can have various embodiments, and specific embodiments are illustrated in the drawings and described in detail in the detailed description. However, this is not intended to limit the present disclosure to specific embodiments, and should be understood to include all modifications, equivalents, or substitutions included in the spirit and technical scope of the present disclosure.

The terms used in the present specification are used only to describe specific embodiments, and are not intended to limit the present disclosure. The singular expression includes the plural expression unless the context clearly indicates otherwise. In the present specification, the term “include” or “have” is intended to specify the presence of features, numerals, steps, operations, components, parts, or combinations thereof described in the specification, and it should be understood not to exclude the presence or the possibility of addition of one or more other features, numerals, steps, operations, components, parts, or combinations thereof in advance.

In addition, the components of the embodiment described with reference to each drawing are not limitedly applied only to the corresponding embodiment, and may be implemented to be included in other embodiments within the scope of maintaining the technical idea of the present disclosure, and further, even if a separate description is omitted, it is natural that a plurality of embodiments may be re-implemented as one embodiment.

In addition, in the description with reference to the accompanying drawings, regardless of reference numerals, the same components will be given the same or related reference numerals and duplicate description thereof will be omitted. When it is decided that the detailed description of the known art related to the present disclosure may unnecessarily obscure the gist of the present disclosure, a detailed description therefor will be omitted.

The embodiment provides a method which utilizes a cluster serving as a mediator in a distributed edge cloud environment, and provides a method which allows a mediator cluster to call a function of an appropriate cluster when each of a plurality of clusters executed in the distributed edge cloud environment calls another function other than a function therein.

Here, the cluster is based on Kubernetes, and is defined as a series of node machines for executing an application container.

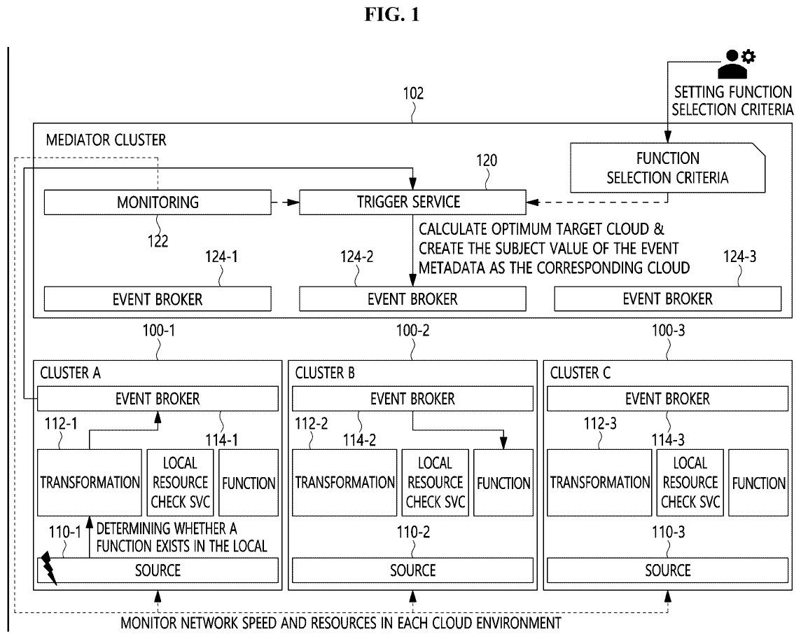

FIG. 1 is a diagram illustrating an event-based optimal FaaS connection system introducing a mediator cluster according to an embodiment.

As illustrated in FIG. 1, the system according to the embodiment may include a plurality of clusters (Cluster A to Cluster C) 100-1 to 100-3, and a mediator cluster 102.

The plurality of clusters 100 may include source components 110-1 to 110-3, transformation components 112-1 to 112-3, and event broker components 114-1 to 114-3.

A source component 110 detects an event, and a transformation component 112 passes a detected event to an event broker component 114.

Here, an event detected by the source component 110 is defined as a first event.

The transformation component 112 discriminates whether a function to be executed by the first event exists in a cluster to which the function belongs to generate a second event in which a type value of event metadata is changed, and passes the generated second event to the event broker component 114.

The event broker component 114 confirms the type value of the event metadata changed by the transformation component 112 to route the second event.

When the type value according to the embodiment is local, that is, when a function to be executed by the first event exists in a cluster to which the function belongs, the type value may be set to 1, otherwise, when the type value is others, the type value may be set to 2.

The event broker component 114 passes the second event which is a value corresponding to a case where the type value of the event metadata is others to the mediator cluster 102.

As illustrated in FIG. 1, the mediator cluster 102 according to the embodiment may include a trigger service component 120, a monitoring component 122, and a plurality of event broker components 124-1 to 124-3 corresponding to the respective clusters 100-1 to 100-3.

The trigger service component 120 filters an optimal target cluster which is to pass the second event by using resource monitoring information collected from a CPU/memory in an environment of each cluster, and the monitoring component 122 which monitors a network speed, etc., and function selection criteria pre-defined by an operator, and generates a third event corresponding to a target cluster.

The event broker component 124 passes the third event to the target cluster.

In FIG. 1, a process of passing an event detected by cluster A 100-1 to cluster B 100-2 is illustrated.

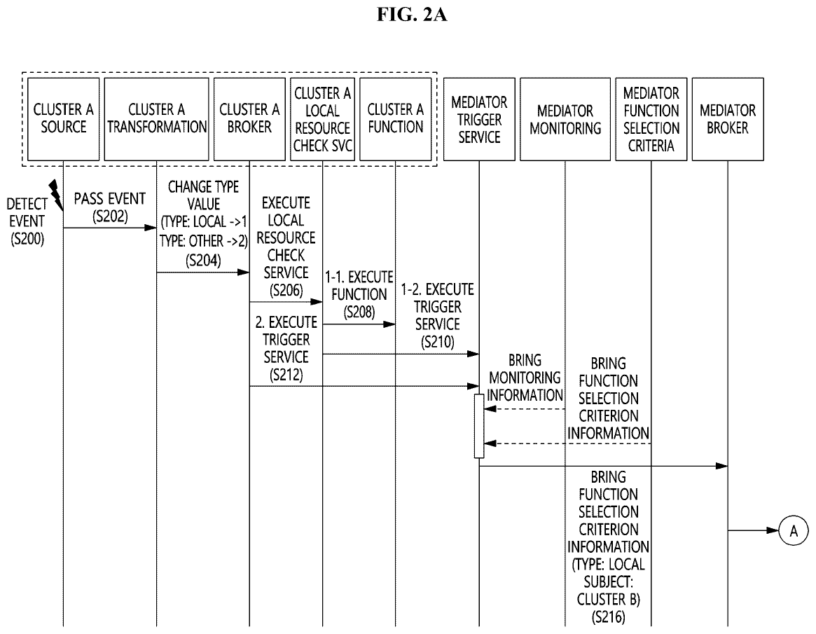

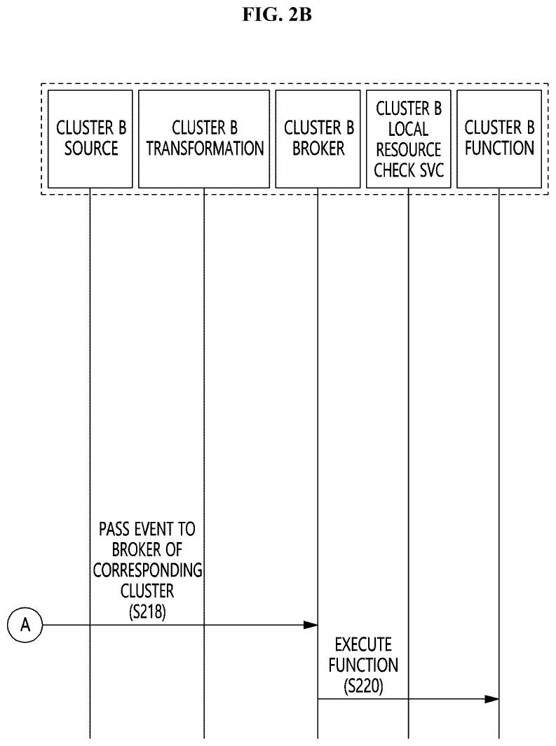

FIG. 2A and FIG. 2B are a diagram illustrating an overall operating process according to an embodiment.

Referring to FIG. 2A and FIG. 2B, when the first event is detected by the source component 110-1 of cluster A 100-1 (step 200), the detected first event is passed to the transformation component 110-2 (step 202).

The transformation component 110-2 changes a type part of event metadata according to whether a function to be executed by the first event exists in a cluster to which the transformation component 110-2 currently belongs, and passes a second event in which a type value is changed to the event broker component 114-1 which belongs to a cluster thereof (step 204).

When the function to be executed by the detected event exists in the cluster to which the transformation component 110-2 belongs, the transformation component 110-2 requests a local resource check SVC to execute a local resource check service (step 206), and the local resource check SVC executes the function by checking a current cluster internal state (CPU/memory) (step 208), or when necessary, passes the event to the mediator cluster 102 (step 210).

When the function to be executed by the event detected in step 204 does not exist in the cluster to which the event broker component 114-1 currently belongs, the event broker component 114-1 passes the second event generated by the transformation component 110-2 to the mediator cluster 102 (step 212).

Here, steps 210 to 212 may be defined as a process of requesting execution of a trigger service.

The trigger service component 120 of the mediator cluster 102 filters the target cluster according to the CPU/memory of the environment of each cluster, the resource monitoring information such as the network speed, and the function selection criterion collected from the monitoring component 122 (step 214).

The trigger service component 120 generates the third event in which the type value of the event metadata is changed to the value corresponding to local, and passes the generated third event to the event broker component 124-2 corresponding to the target cluster (step 216).

The event broker component 124-2 passes the third event to the event broker component 114-2 of the target cluster (cluster B) 100-2 (step 218).

Thereafter, the function requested by the target cluster is executed (step 220).

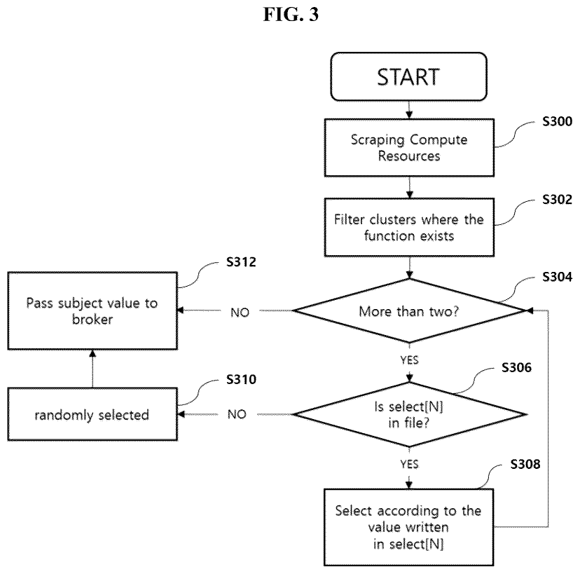

FIG. 3 is a flowchart illustrating an optimal function selecting process of a trigger service component according to an embodiment.

Referring to FIG. 3, the trigger service component 120 collects the CPU/memory of each cluster, and the resource monitoring information such as the network speed from the monitoring component 122 (step 300).

Next, the trigger service component 120 filters a target cluster in which a function to be called (executed) by the detected event is registered (step 302).

At this time, it is determined whether there are two or more filtered clusters (step 304), when there are two or more selected target clusters, it is checked whether there is a function selection criterion file pre-registered from an operator (step 306), and when there is the function selection criterion file, one target cluster is selected by using the corresponding file (step 308).

When there is no file, or when there is the file, but there is no value any longer, one of two or more target clusters is randomly selected (step 310).

When there is one target cluster filtered in step 304, or the target cluster is randomly selected as in step 310, the event is passed to the event broker component of the corresponding target cluster (step 312).

The event-based optimal FaaS connection method in the distributed edge cloud environment described above may be implemented even in the form of a recording medium including a command executable by a computer such as an application or a program module executed by the computer. A computer readable medium may be any available medium accessible by the computer or includes all of volatile and non-volatile media, and removable and irremovable media. Further, the computer readable medium may include computer storage media. The computer storage media include all of the volatile and non-volatile, and removable and irremovable media implemented by any method or technology for storing information such as a computer readable command, a data structure, a program module, or other data.

The above-described embodiments of the present disclosure have been disclosed for illustrative purposes, and those skilled in the art having ordinary knowledge of the present disclosure will be able to make various modifications, changes, and additions within the spirit and scope of the present disclosure, and such modifications, changes, and additions should be considered to fall within the scope of the following claims.

What is claimed is:

1. An event-based optimal Function-as-a-Service (FaaS) connection method in a distributed edge cloud environment, comprising:
generating, by a transformation component of a first cluster among a plurality of clusters, a second event by changing a type value of an event metadata according to whether a function to be executed by a first event detected by the first cluster exists in the first cluster;
passing, by a first event broker component of the first cluster, the second event to a trigger service component of a mediator cluster when the function to be executed does not exist in the first cluster;
filtering, by the trigger service component, a target cluster by referencing resource monitoring information of each cluster environment and a pre-defined function selection criterion file, and generating a third event corresponding to the target cluster; and
passing, by a second event broker component corresponding to the filtered target cluster of the mediator cluster, the third event to the first event broker component.

2. The event-based optimal FaaS connection method of claim 1, wherein the transformation component changes the type value to 1 corresponding to local when the function exists in the first cluster, and changes the type value to 2 corresponding to others when the function does not exist in the first cluster.

3. The event-based optimal FaaS connection method of claim 2, wherein the trigger service component generates the third event by changing a metadata type value of the second event to 1 corresponding to local.

4. The event-based optimal FaaS connection method of claim 1, wherein the resource monitoring information includes a CPU/memory usage and a network speed.

5. The event-based optimal FaaS connection method of claim 1, wherein when a plurality of target cluster candidates are filtered by using the resource monitoring information of each cluster environment, the trigger service component filters one of the plurality of target cluster candidates as the target cluster by referencing the pre-defined function selection criterion file.

6. The event-based optimal FaaS connection method of claim 1, wherein when a plurality of target clusters are determined by referencing the pre-defined function selection criterion file, the trigger service component randomly determines one target cluster.

7. The event-based optimal FaaS connection method of claim 1, wherein the mediator cluster includes a plurality of event brokers corresponding to the plurality of clusters.

8. An event-based optimal Function-as-a-Service (FaaS) connection device in a distributed edge cloud environment, comprising:
a trigger service component receiving, when a function to be executed by a first event detected by a first cluster among a plurality of clusters does not exist, a second event in which a metadata type value of the first event is changed from the first cluster, and filtering a target cluster by using resource monitoring information of each of the plurality of clusters and a pre-defined function selection criterion and generating a third event corresponding to the target cluster; and
a plurality of event broker components corresponding to the plurality of clusters,
wherein an event broker component corresponding to the filtered target cluster among the plurality of event broker components passes the third event to the target cluster.

9. The event-based optimal FaaS connection device of claim 8, wherein when a plurality of target cluster candidates are filtered by using the resource monitoring information of each cluster environment, the trigger service component determines one of the plurality of target cluster candidates as the target cluster by referencing the pre-defined function selection criterion.

10. The event-based optimal FaaS connection device of claim 8, wherein a transformation component of the first cluster changes the metadata type value to 1 corresponding to local when the function exists in the first cluster, and changes the metadata type value to 2 corresponding to others when the function does not exist in the first cluster.

11. The event-based optimal FaaS connection device of claim 10, wherein the trigger service component generates the third event by changing a metadata type value of the second event to 1 corresponding to local.

12. An event-based optimal Function-as-a-Service (FaaS) connection system in a distributed edge cloud environment, comprising:
a plurality of clusters including a source component detecting a first event, a transformation component generating a second event by changing a metadata type value of the first event according to whether a function to be executed by the first event exists in a cluster thereof, and an event broker component routing the second event when the function does not exist in a cluster thereof; and
a mediator cluster including a trigger service component filtering a target cluster by referencing resource monitoring information of each cluster environment, and a pre-defined function selection criterion file, and generating a third event corresponding to the target cluster, when receiving the second event from an event broker component of one cluster among the plurality of clusters, and a plurality of event broker components corresponding to the plurality of clusters,
wherein an event broker component corresponding to the filtered target cluster among the plurality of event broker components passes the third event to an event broker component included in the target cluster.
